(19) United States
(12) Patent Application Publication
(10) Pub. No.: US 2024/0261790 A1
(43) Pub. Date: Aug. 8, 2024

(54) DEVICE FOR CONTROLLING THE TEMPERATURE OF A MEASURING CELL AND METHOD FOR OPERATING THE DEVICE

(71) Applicant: 3 P INSTRUMENTS GMBH & CO. KG, 85235 Odelzhausen (DE)

(72) Inventors: ROBERT ESCHRICH, Leipzig (DE); DIETMAR KLANK, Odelzhausen (DE); ANDREAS SEIDLER, Leipzig (DE); MATTHIAS GRAF, Leipzig (DE)

(73) Assignee: 3 P INSTRUMENTS GMBH & CO. KG, 85235 Odelzhausen (DE)

(21) Appl. No.: 18/290,437

(22) PCT Filed: May 6, 2022
(86) PCT No.: PCT/DE2022/100350

§ 371 Date: Nov. 13, 2023

(30) Foreign Application Priority Data
May 14, 2021 (DE) 10 2021 112 581.2

(51) Int. Cl. B01L 7/00

(52) U.S. Cl. CPC B01L 7/52; B01L 2300/1822; B01L 2300/1894

(57) ABSTRACT

A device for controlling the temperature of a gas-sorption measuring cell includes a vessel for a cooling medium and a measuring apparatus. The measuring apparatus has a temperature-controlling element with an opening for receiving the measuring cell and has further a cooling device for controlling the temperature of the temperature-controlling element, which contact each other in the direction of a longitudinal axis for heat transfer there between. The temperature-controlling element is affixed on a wall of the vessel with a fastening element for heat exchange between the measuring apparatus and the cooling medium. Arranged between the temperature-controlling element and the cooling device is a thermoelectric cooling element for cooling the temperature-controlling element and the measuring cell. A method for operating the device for controlling the temperature of the measuring cell is also disclosed.

The invention relates to a device for the targeted controlling of the temperature of a measuring cell, in particular a gas sorption measuring cell for adsorption analyses for material characterization at different temperatures, using a primary cooling medium. The device is formed with an insulated vessel arranged within an insulation container for receiving the cooling medium and a measuring apparatus. The measuring apparatus has a temperature-controlling element with a receiving opening for receiving the measuring cell and also has a cooling device for controlling the temperature of the temperature-controlling element. The invention also relates to a method for operating the device.

Solid surfaces are conventionally characterized using gas adsorption. The associated analyses are usually carried out in vacuum apparatus at pressures of less than 10′ bar up to the saturation vapor pressure of the probe molecule used. The largest possible measuring range is achieved with a measuring temperature at which the saturation vapor pressure corresponds to the maximum possible pressure of the vacuum apparatus. The maximum possible pressure of the vacuum apparatus is usually atmospheric pressure. This results in the measuring temperature being the boiling temperature of the probe molecule used.

With its virtual inertness and its simple and cost-effective availability compared to other gases, nitrogen has become the standard cooling medium and standard probe molecule for gas sorption measurements to characterize solid surfaces as a cryogenic liquid for cooling the measuring cell to a measuring temperature of 77 K or −196° C. However, there are also findings that questioned the absolute suitability of nitrogen for such analyses and ultimately led to a general recommendation in 2015 for the use of the noble gas argon by the “International Union of Pure and Applied Chemistry”, IUPAC for short, German “Internationale Union für reine und angewandte Chemie”.

On the one hand, the advantage of argon over nitrogen lies in the fact that the single atom noble gas has no quadrupole moment, which reduces undesirable interactions between the solid surface and the adsorbed probe molecule, also in short referred to as adsorbate. On the other hand, analogous to analyses with nitrogen, liquid argon must be used to cool the measuring cell to a measuring temperature of around 87 K or −186° C., which is not commercially available everywhere and is significantly more expensive than nitrogen. As a result, analyses of solid surfaces with argon are not very widespread.

US 2017 0370817 A1 discloses a device with which a measuring cell holder arranged in a Dewar container filled with liquid nitrogen at a temperature of 77 K can be heated to 87 K by targeted heating, and regulated. By carefully selecting certain materials with regard to thermal conductivity coefficients and geometries, defined temperature ranges are obtained.

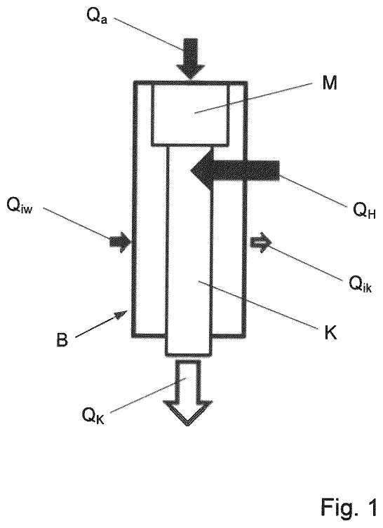

The design of such a device for controlling the temperature of a measuring cell and regulating the temperature are substantially based on the compensation of heat flows. FIG. 1 shows schematically the control volume B of the device for controlling the temperature of a measuring cell with a measuring point M and a heat sink K.

As a result of the imperfection of the insulation used, a heat Qᵢₖ short for heat flow insulation cold (from German: Wärmestrom isolation kalt), is transferred through an outer wall of the device, specifically a housing, and then into the liquid for cooling, in particular the liquid nitrogen. The liquid nitrogen level is high at this point. In addition, when the liquid nitrogen fill levels are low, heat Q_{iw}, short for heat flow insulation warm (from German: Wärmestrom Isolation warm), flows into the control volume B from the gas phase located above the fill level line. Both amounts of heat depend on temperature and level and are negligible for further considerations.

Furthermore, heat Qₐ flows in through the upper side of the device, which is poorly insulated compared to the housing due to its design. The upper side ensures access to the measuring chamber and the measuring point M of the device, which affects the insulation. In addition, heat Q_{K} is transferred from the heat sink K into the liquid nitrogen, which evaporates in accordance with the heat introduced. The cooling of the heat sink K is therefore guaranteed by the enthalpy of vaporization of the liquid nitrogen. As the liquid nitrogen evaporates, the level drops until the liquid nitrogen has completely evaporated.

The device has a constant temperature at the measuring point M if the following equation is met

$${Q}_{K} = {Q}_{a} + {Q}_{H} .$$

In order to ensure a constant temperature in the device, in particular at the measuring point M, just as much thermal heat Q_{H} is introduced into the device so that the difference in flows between the heat O_{K} dissipated by the heat sink K and the heat penetrating from the outside into the device is just balanced. The heat flowing into the device is regulated using a control circuit.

With such devices known from the prior art, the balancing of the heat flows and thus the required constant temperature are achieved through targeted heating, in particular a targeted supply of heat in the area between the measuring point M, especially a measuring cell holder, and the heat sink K. Hereby, the thermal heat Q_{H} serves both to control the temperature of the measuring cell holder or the measuring point M and to compensate for the heat dissipated by the heat sink K. Maintaining the specific temperature of the measuring point M is therefore regulated at the expense of the evaporation of liquid nitrogen and thus the available measuring time, which, particularly in the case of microporous adsorbents, can lead to a sorption isotherm not being able to be completely measured.

The entire device must be designed for the specific temperature. If the cooling power is too low, for example due to material selection or geometry, the desired cryogenic temperatures will not be achieved. For analyses at higher temperatures, however, a larger thermal heat Q_{H} is required, which is, however, compensated for by evaporation of a larger amount of liquid nitrogen. As a result, at temperatures above the design temperature of the device, the available measuring time is significantly reduced, which is then no longer sufficient for certain analyses.

In addition to the device shown and the principle implemented with it, there are other methods for carrying out sorption analyses or sorption tests at a certain temperature. These include, among other things, the use of so-called cryostats and cryocoolers, i.e. compression refrigeration machines, and as direct cooling with cryogenic liquids in conjunction with devices to enable the analyses.

For example, WO 2020 157646 A1 shows a sample vessel arrangement for carrying out sorption analyzes in a container filled with a coolant. The arrangement has a sample vessel suspended in the container with a sample receiving area for receiving the sample to be analyzed and a wick. The wick surrounding the sample receiving area extends from the sample receiving area towards a bottom of the container and draws the cooling liquid over the sample receiving area.

In analyses in cryogenic liquid known from the prior art, the temperature of the cryogenic liquid depends on its purity and on the air pressure via the saturation vapor pressure, which can lead to weather-dependent temperature changes of several tenths of Kelvin over the measurement period lasting several hours.

The object of the present invention is to provide a device for controlling the temperature of a measuring cell for gas sorption analyses in a wide temperature range. The service life for the analyses should be maximum across the entire temperature range. The device should be simple to construct and to produce, and the costs of production and operation, especially for analyses, should be minimal. It should also be possible to carry out the analyses at stable temperatures.

The object is achieved by a device according to the invention for controlling the temperature of a measuring cell, in particular for controlling the temperature of a gas sorption measuring cell to cryogenic temperatures. The device is formed with an insulated vessel, arranged in particular within an insulation container, for receiving a cooling medium and a measuring apparatus. The measuring apparatus has a temperature-controlling element with a receiving opening for receiving the measuring cell and also has a cooling device for controlling the temperature of the temperature-controlling element. The temperature-controlling element and the cooling device are aligned in the direction of a longitudinal axis and lie against one another and exchange heat. Here, the cooling device has a fastening element for fixing the temperature-controlling element on a wall of the vessel and for the heat exchange between the measuring apparatus and the cooling medium.

According to the concept of the invention, a thermoelectric cooling element for cooling the temperature-controlling element and the measuring cell is arranged in the direction of the longitudinal axis of the device between the temperature-controlling element and the cooling device.

The design of the thermoelectric cooling element has the advantage that no portion of the cooling medium is consumed by additional heating of the device, especially by additional heating of the temperature-controlling element. Cryogenic liquids such as liquid nitrogen and fluids with a boiling point below 123.15 K, but also cooling liquids with boiling points below 230 K, can preferably be used as the cooling medium.

The insulated vessel for receiving the cooling medium and the measuring apparatus is preferably designed as a multi-walled, in particular double-walled, vessel. In this case, the space between the walls is high-vacuum insulated.

The temperature-controlling element with the receiving opening and the measuring cell are preferably each designed to be rotationally symmetrical about the longitudinal axis.

According to a refinement of the invention, the thermoelectric cooling element has the shape of a disk, for example a circular disk. The thermoelectric cooling element, which is advantageously designed as a Peltier element, lies preferably flat against an underside of the temperature-controlling element with an upper side aligned in the direction of the longitudinal axis.

According to a preferred configuration of the invention the device is formed with at least one temperature sensor for determining the temperature of the temperature-controlling element and the measuring cell, and a regulating device. The temperature sensor is connected to the regulating device, in particular electrically.

An advantage of the invention is that the thermoelectric cooling element is electrically connected to the regulating device. Hereby, the regulating device is configured in such a way that it uses a signal received from the temperature sensor to control the thermoelectric cooling element, and to keep a specified target value of the temperature of the temperature-controlling element constant.

According to an advantageous configuration of the invention, the cooling device has a heat sink, a heat exchange element and at least one spring element, which can be designed rotationally symmetrically about the longitudinal axis of the device.

The heat sink and the fastening element are preferably in direct contact and firmly connected to one another, in particular screwed together, or designed in one piece. The one-piece design is understood to mean a component made or formed from one piece or one part.

The heat sink or the fastening element is advantageously made of a material with a high thermal conductivity coefficient, in particular a thermal conductivity coefficient greater than 100 W/(m·K), in particular made of copper.

According to a refinement of the invention, the cooling device has a thermal shunt element, which is arranged between the heat sink and the temperature-controlling element in the direction of the longitudinal axis of the device. Here, the heat sink and the shunt element on the one hand, and the shunt element and the temperature-controlling element on the other hand are each firmly connected to one another, in particular screwed together. The shunt element can be formed of a material with a thermal conductivity coefficient of less than 40 W/(m·K), in particular stainless steel.

The thermoelectric cooling element can be arranged between the temperature-controlling element and the heat exchange element in the direction of the longitudinal axis of the device. In addition, the thermoelectric cooling element preferably full-circumferentially encloses the shunt element, so that the thermoelectric cooling element is arranged centered about the longitudinal axis of the device.

According to a preferred configuration of the invention, the at least one spring element of the device, especially the cooling device, is arranged such that the thermoelectric cooling element is arranged so as to be pressed against the temperature-controlling element due to the spring force of the at least one spring element. The at least one spring element is preferably designed as a disk spring and is arranged between the heat sink and the heat exchange element in the direction of the longitudinal axis of the device.

The heat sink advantageously has the shape of a cylinder, in particular a circular cylinder, with an axis aligned in the direction of the longitudinal axis of the device and a collar protruding from an outer lateral surface in the radial direction. The collar is arranged in particular on the underside of the heat sink pointing towards the fastening element and full-circumferentially about the lateral surface.

The heat exchange element is preferably designed in the form of a hollow cylinder, in particular a hollow circular cylinder, with an axis aligned in the direction of the longitudinal axis of the device. Here, the outer lateral surface of the heat sink and the inner lateral surface of the heat exchange element correspond to one another in terms of dimensions and shape, so that the heat sink and the heat exchange element lie against one another over the entire surface of the lateral surfaces. The heat exchange element is movable, in particular displaceable, in relation to the heat sink in the direction of the longitudinal axis of the device.

The heat exchange element, which is preferably made of copper, advantageously has a collar protruding from an inner lateral surface in the radial direction on an end face aligned towards the temperature-controlling element.

According to a first alternative configuration of the invention, the at least one spring element is arranged between an upper side of the collar of the heat sink pointing in the direction of the cooling element, the collar protruding from the outer lateral surface in the radial direction, and an end face of the heat exchange element opposite the collar of the heat sink.

According to a second alternative configuration of the invention, the at least one spring element is arranged between the upper side of the heat sink pointing in the direction of the cooling element and the collar protruding from the inner lateral surface of the heat exchange element in the radial direction.

In a design of the device with two spring elements, a first spring element can be arranged between the upper side of the collar of the heat sink which protrudes from the outer lateral surface in the radial direction and points in the direction of the cooling element, and an end face of the heat exchange element opposite the collar of the heat sink, while a second spring element can be arranged between the upper side of the heat sink pointing in the direction of the cooling element, the collar protruding from the inner lateral surface of the heat exchange element in the radial direction.

According to a refinement of the invention, a first sub-area of the fastening element is arranged so as to be in direct contact with the cooling medium.

The temperature-controlling element, the thermoelectric cooling element, the heat exchange element and a second sub-area of the fastening element are advantageously aligned coaxially to the longitudinal axis of the device and are each full-circumferentially surrounded by an insulation element on an outer lateral surface. Here, the insulation element can be full-circumferentially surrounded by a layer element on an end face aligned downwards in the direction of the longitudinal axis and on an outer lateral surface.

A further advantage of the invention is that the fastening element is designed to be rod-shaped, in particular round rod-shaped, and is designed in one piece or multi-piece.

The multi-piece fastening element preferably has a heat dissipation element, a stand element and a jacket element, which are arranged coaxially to the longitudinal axis of the device. The heat dissipation element and the stand element can lie against one another on end faces facing one another in the direction of the longitudinal axis.

The heat dissipation element is preferably made of a material with a thermal conductivity coefficient greater than 200 W/(m·K), in particular made of copper.

The jacket element, which in particular encloses the first sub-area of the fastening element and the stand element, each full-circumferentially on the lateral surface and in the direction of the longitudinal axis of the device, in particular over the entire length or height, is advantageously arranged at least partially within the cooling medium and is made of a porous material for transporting the cooling medium to the first sub-area of the fastening element.

The jacket element, which preferably has a hollow cylindrical, in particular hollow circular cylindrical shape, can be full-circumferentially surrounded by a layer element on an outer lateral surface.

The object is also achieved by a method according to the invention for operating the device for controlling the temperature of a measuring cell, in particular for controlling the temperature of a gas sorption measuring cell to cryogenic temperatures, and for keeping the temperature of the measuring cell constant at a specified target value in a time interval for carrying out analyses, especially adsorption analyses for material characterization. The method comprises the following steps:
immersing a fastening element of a cooling device, which is in thermally conductive contact with the measuring cell for heat exchange via a temperature-controlling element, into a cooling medium,
determining the temperature of the temperature-controlling element and comparing the temperature with the specified temperature target value, and
regulating the temperature by means of a thermoelectric cooling element thermally coupled to the temperature-controlling element for cooling the temperature-controlling element and keeping the specified target temperature of the temperature-controlling element constant during the time interval.

The heat penetrating into the device and especially the temperature-controlling element or the measuring cell is dissipated through the thermoelectric cooling element and into the cooling medium.

According to a refinement of the invention the thermoelectric cooling element is pressed against the temperature-controlling element with at least one spring element to ensure optimal heat exchange. Different thermal expansions can also be compensated for.

The temperature range, in particular the position and size of the temperature range in which the temperature of the measuring cell can be controlled and regulated is set by the material and the dimensioning of a shunt element of the cooling device arranged between the temperature-controlling element and the fastening element.

The device according to the invention and the method according to the invention have various further advantages:
enabling analyses, in particular gas sorption investigations, in a wide temperature range, for example at temperatures in the range from 70 K to 325 K or in the range from −203° C. to +52° C.,
regulating the temperature of the measuring cell by compensating for the heat flows, in particular from the environment, exclusively by specifically varying the cooling power and thus by dissipating heat from the device instead of by specifically varying a heating power with the introduction of an additional heating power,
thereby minimal heat flow into the cooling medium, in particular the cryogenic liquid, so that only a minimal part of the cryogenic liquid evaporates per unit of time, as a result
maximum service life and measuring time,
minimal dependence of the service life on the set target temperature,
possibility of very low temperatures close to the vaporization temperature of the cryogenic liquid, in the case of liquid nitrogen at around 77 K, and
minimal consumption of cooling medium, resulting in lower costs and conservation of resources.

In comparison to analyses known from the prior art and carried out directly in the cryogenic liquid, for example with argon as a probe molecule and liquid argon as a cryogenic liquid, the measurement temperature is not dependent on the air pressure and on the purity of the cryogenic liquid via the saturation vapor pressure, but is actively regulated, which guarantees analyses at very stable measuring temperatures.

Further details, features and advantages of the invention are apparent from the following description of exemplary embodiments with reference to the associated drawings, in which:

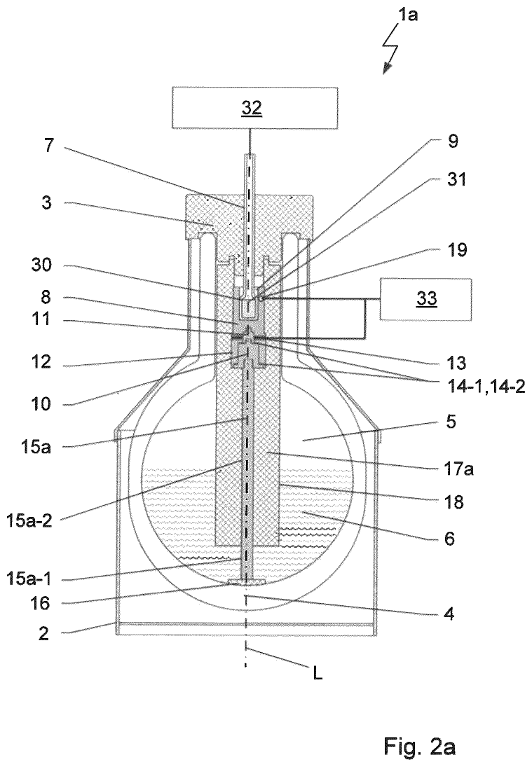

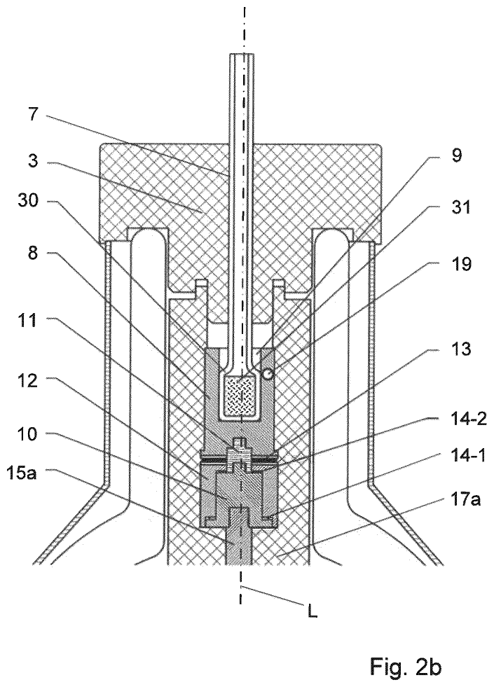

FIG. 2a: shows a first embodiment of a device according to the invention for controlling the temperature of a measuring cell with a measuring apparatus arranged within an insulation container and a one-piece fastening element,

FIG. 2b: the first embodiment according to FIG. 2a in a detailed representation of the measuring cell arranged within a temperature-controlling element, and

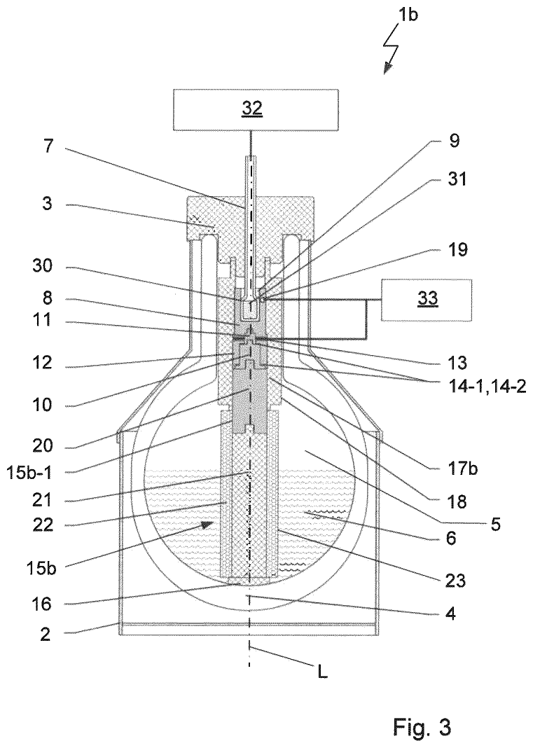

FIG. 3: a second embodiment of a device according to the invention for controlling the temperature of a measuring cell with a measuring apparatus arranged within an insulation container and a multi-piece fastening element.

FIGS. 2a and 2b show a first embodiment of a device 1a according to the invention for controlling the temperature of a measuring cell 30, specifically a gas sorption measuring cell, with a measuring apparatus arranged within an insulation container 2 and a one-piece fastening element 15a. FIG. 2b shows a detailed representation of the first embodiment according to FIG. 2a, in particular the measuring cell 30 arranged within a temperature-controlling element 8.

The insulation container 2 has an outer wall enclosing a volume with a cover element 3 for closing the volume on an upper side. The terms upper and lower side each refer to the vertical orientation of the device 1a, in which the longitudinal axis L is also aligned. The volume enclosed by the insulation container 2 is limited on the underside by a bottom.

A multi-walled, in particular double-walled, vessel 4, also referred to as a Dewar vessel, is arranged within the isolation container 2. The wall of the vessel 4 encloses a vacuum volume for the thermal insulation of a cavity 5 enclosed by the vessel 4. Cavity 5, which is vacuum-insulated as a result, serves to receive a cryogenic liquid 6, for example liquid argon or preferably liquid nitrogen, and can have a filling volume of about 3000 cm³.

The cavity 5 is partially filled with the cryogenic liquid 6. The measuring apparatus, which is also arranged within the vacuum-insulated cavity 5, is partially fixed within the cryogenic liquid 6 and thus surrounded by the liquid 6 and extends in the axial direction along the longitudinal axis L from a bottom of the vessel 4 to an opening formed on the upper side of the vessel 4. The opening serves to receive the measuring apparatus and is closed with the cover element 3, which also serves to close the insulation container 2.

The cover element 3 is formed with a through opening 7 for passing through the measuring cell 30 and serves for thermal insulation and to protect the measuring apparatus from freezing due to condensation and freezing of moisture condensing from the surrounding air. The cover element 3 is made of a material with a thermal conductivity coefficient of less than 1 W/(m·K), in particular PTFE.

The measuring apparatus has the temperature-controlling element 8 with a receiving opening 9 for receiving the measuring cell 30, and a cooling device. The receiving opening 9, which is circular in cross section, extends downwards in the vertical direction from an upper side of the cylindrical, specifically circular cylindrical temperature-controlling element 8, so that the temperature-controlling element 8 essentially has the shape of a hollow cylinder or circular hollow cylinder with a closed bottom. The measuring cell 30 lies flat on the bottom of the temperature-controlling element 8.

In addition, the inner diameter of the receiving opening 9 of the temperature-controlling element 8 corresponds to the outer diameter of the measuring cell 30 plus a small amount of clearance for inserting the measuring cell 30 into the receiving opening 9, so that the lateral surface of the measuring cell 30 also lies flat against the temperature-controlling element 8. The temperature-controlling element 8 with the receiving opening 9 and the measuring cell 30 are designed to be rotationally symmetrical about the longitudinal axis L.

The shapes of the receiving opening 9 and the measuring cell 30 correspond to one another in such a way that there is a maximum contact surface between the temperature-controlling element 8 and the measuring cell 30 for maximum heat exchange. The measuring cell 30, which is connected to a gas sorption instrument 32, receives the sample 31 to be examined and the measurement gas.

The temperature-controlling element 8 is made of a material with a high thermal conductivity coefficient, in particular with a thermal conductivity coefficient greater than 100 W/(m·K), preferably made of copper.

The circular cylindrical temperature-controlling element 8 can have an extension of 42 mm in the direction of the longitudinal axis L and substantially an outer diameter of 27 mm. In the area of the bottom, the inner diameter of the temperature-controlling element 8 can be 30 mm with an extension in the direction of the longitudinal axis L of about 2 mm. The receiving opening 9 is designed with a depth in the range of 28 mm to 30 mm, in particular 28.5 mm, and an inner diameter in the range of 16 mm to 18 mm, especially 16.2 mm.

In addition, the temperature-controlling element 8 has on the bottom, on the underside opposite the contact surface with the measuring cell 30, a fastening for the cooling device in the form of an opening, in particular with a depth of 3 mm, with a metric fine thread MF5 as an internal thread.

The cooling device is formed from a heat sink 10, a thermal shunt element 11, also referred to as a shunt, and a sleeve-shaped heat exchange element 12. The shunt element 11 serves, among other things, to center and fix a thermoelectric cooling element 13. In addition, the cooling device has spring elements 14-1, 14-2, and a rod-shaped, in particular round rod-shaped, fastening element 15a.

The heat sink 10, which is made of a material with a high thermal conductivity coefficient, in particular with a thermal conductivity coefficient greater than 100 W/(m·K), preferably made of copper, is firmly connected to the temperature-controlling element 8 via the thermal shunt element 11. The shunt element 11, which is designed rotationally symmetrically about the longitudinal axis L, is screwed, for example, into the opening provided with the internal thread in the bottom of the temperature-controlling element 8.

The shunt element 11 establishes a mechanically stable connection between the temperature-controlling element 8 and the heat sink 10 and is made of a material with a lower thermal conductivity coefficient than the heat sink 10, in particular less than 40 W/(m·K), for example made of stainless steel. Both the position and the size of the temperature range in which the measuring apparatus can be operated and regulated are determined by the material and the dimensioning, especially the diameter and length, of the shunt element 11. The heat sink 10, which is also designed to be rotationally symmetrical about the longitudinal axis L, can in turn be screwed into the shunt element 11, for example, into an opening provided with an internal thread. The shunt element 11 can have an extension in the direction of the longitudinal axis L, also referred to as height, of 10 mm with an outer diameter of 9 mm. On the underside pointing to the heat sink 10, the shunt element 11 can be formed with a metric fine thread MF5 as an internal thread for connecting to the heat sink 10, and on the upper side pointing to the temperature-controlling element 8 it can be formed with a metric fine thread MF5 as an external thread. The shunt element 11 can be screwed into the opening formed in the bottom of the temperature-controlling element 8.

The heat sink 10 can have an extension in the direction of the longitudinal axis L, or a height, of 22 mm with an outer diameter of 18 mm. A collar, for example with a height of 3 mm and an outer diameter of 25 mm, is formed on the underside pointing to the fastening element 15a. On the upper side of the heat sink 10, which is aligned distally to the underside, a metric fine thread MF5 can be provided as an external thread for connecting to the shunt element 11.

Between the temperature-controlling element 8 and the heat exchange element 12, a circular, in particular annular, thermoelectric cooling element 13 is also provided. The thermoelectric cooling element 13, designed as a Peltier element, full-circumferentially encloses the shunt element 11. In this case, the inner diameter of the cooling element 13 is larger than the outer diameter of the shunt element 11. The cooling element 13 can have an extension in the direction of the longitudinal axis L and consequently a height of 4 mm with an outer diameter of 30 mm and an inner diameter of 10 mm.

The cooling element 13 is pressed onto the underside of the temperature-controlling element 8 by means of the sleeve-shaped heat exchange element 12. The contact pressure is generated via the spring elements 14-1, 14-2, which are specially designed as disk springs and which are arranged between the heat sink 10 and the heat exchange element 12.

Here, a first spring element 14-1 is arranged between an upper side of the collar of the heat sink 10 pointing in the direction of the cooling element 13 and an end face of the heat exchange element 12 opposite the collar of the heat sink 10. The first spring element 14-1 has an inner diameter in the range of 15 mm to 25 mm, especially in the range of 18 mm to 20 mm, in particular 18.3 mm, and is configured in such a way as to generate a mean contact pressure of 33 N.

A second spring element 14-2 is arranged between the upper side of the heat sink 10 pointing in the direction of the cooling element 13 and a collar protruding from an inner lateral surface of the heat exchange element 12, and has an inner diameter of 11 mm. The second spring element 14-2 is configured so as to generate a mean contact pressure of 18 N.

With the spring elements 14-1, 14-2, the contact pressure is exerted on the heat exchange element 12, which is movable in relation to the heat sink 10 in the direction of the longitudinal axis L, which presses the thermoelectric cooling element 13 flat against an underside of the temperature-controlling element 8 pointing in the direction of the heat exchange element 12.

The thermal coupling between the temperature-controlling element 8 and the heat sink 10 via the shunt element 11 must be designed small enough so that a large temperature regulation range of the measuring apparatus is possible, but must also be configured large enough so that too great a difference between the temperature of the temperature-controlling element 8 and the heat sink 10 is avoided. A large temperature difference could damage the thermoelectric cooling element 13.

The heat flow between the temperature-controlling element 8 and the cooling device is controlled directly by means of the thermoelectric cooling element 13.

The outside or outer lateral surface of the heat sink 10 and the inside or inner lateral surface of the heat exchange element 12 correspond to one another, in particular with minimal surface roughness and therefore a smooth design, and aligned coaxially with one another, so as to guarantee maximum heat exchange from the heat exchange element 12 to the heat sink 10. The thermal contact between the heat sink 10 and the heat exchange element 12 can be further improved by using a thermal paste.

The heat exchange element 12, which is made of the same material as the heat sink 10, in particular made of copper, can have an extension in the direction of the longitudinal axis L, or a height, of 25 mm with an outer diameter of 30 mm. The inner diameter of the heat exchange element 12 may be 18 mm in a large central section. In a lower section aligned towards the fastening element 15a with an extension in the direction of the longitudinal axis L of about 5 mm, the inner diameter of the heat exchange element 12 can be 26 mm, while the inner diameter of the heat exchange element 12 in an upper section aligned towards the cooling element 13 with an extension of 3 mm in the direction of the longitudinal axis L can be 10 mm.

The contact pressure of the cooling element 13 on the temperature-controlling element 8 generated by means of the spring elements 14-1, 14-2 also ensures that the maximum heat exchange is still guaranteed even if different expansions, in particular changes in length, of the components occur due to cooling of the device 1a. Here, mechanical stresses that build up due to different materials with different thermal expansion coefficients, such as different metals and ceramic components of the cooling element 13, are automatically compensated or balanced by means of the spring elements 14-1, 14-2.

On an underside, the heat sink 10 is connected to the rod-shaped fastening element 15a. The fastening element 15a, which is designed so as to be rotationally symmetrical about the longitudinal axis L, is, for example, in turn, screwed into an opening which is provided with an internal thread in the heat sink 10. The diameter of the fastening element 15a is smaller over the entire length than the inner diameter of the sleeve-shaped heat exchange element 12 and therefore also smaller than the diameter of the heat sink 10 enclosed by the heat exchange element 12.

The round rod-shaped fastening element 15a can be designed with a length of 183 mm, an outer diameter of 10 mm and can be made of copper. At the upper end of the fastening element 15a aligned with the heat sink 10, a metric external thread M8 can be provided for screwing to the heat sink 10, while at the lower end of the fastening element 15a distal to the upper end, a metric internal thread M3 can be provided.

A first sub-area 15a-1 of the fastening element 15a serving as a thermally conductive element is in direct contact with the cryogenic liquid 6 as a cooling medium. The first sub-area 15a-1 can be flushed with cooling medium over an extension of 28 mm in the direction of the longitudinal axis L, so that the first sub-area 15a-1 has a lateral surface of 8.8 cm².

The fastening element 15a has a support element 16 on the vertically downward-aligned end face. The support element 16 is designed in the form of a foot made of a plastic, for example PTFE, in order, on the one hand, to fix the fastening element 15a on the end face within the cavity 5 on the vessel 4 and, on the other hand, to avoid damage to the vessel 4. The support element 16, which has the shape of a circular disk, can be designed with an outer diameter of 32 mm and a thickness of 5 mm. The curved underside of the support element 16 corresponds in this case to the curvature of the vessel 4 on the support surface. The support element 16 can be provided with an external thread which corresponds to the metric internal thread M3 provided at the lower end of the fastening element 15a for connection.

The temperature range for the analyses with the measuring apparatus is also specified by the design of the fastening element 15a as a heat dissipation rod. In this case, the thermal conduction and thus the temperature range for the analyses are determined using three parameters. The first parameter is the thermal conductivity coefficient of the material and thus the material from which the fastening element 15a is made. The second parameter is the diameter and thus the cross-sectional area of the rod-shaped fastening element 15a, which determines the heat flow, while the third parameter is the length of the rod-shaped fastening element 15a in the direction of the longitudinal axis L. A high thermal conductivity coefficient of the material, a large cross-sectional area, i.e. a large diameter, and a short length of the rod-shaped fastening element 15a each result in high heat conduction, so that analyses with the measuring cell 30 can be made possible at very low temperatures, for example close to 77 K. The formation of the fastening element 15a from materials with a low thermal conductivity coefficient and a small cross-sectional area, that is to say a small diameter, and a large length result in lower heat conduction, so that analyses can be carried out at higher temperatures using the measuring cell 30, for example at about 195 K, which enables other gas sorption experiments, for example with carbon dioxide, CO₂ for short, but also other probe molecules.

The temperature-controlling element 8, the thermoelectric cooling element 13, the heat exchange element 12 and the fastening element 15a, which are aligned coaxially and along the longitudinal axis L, are each full-circumferentially jacketed on the outer lateral surface with an insulation element 17a, especially an insulation foam, with a thermal conductivity coefficient of less than 1 W/(m·K). The insulation element 17a lies against the outer lateral surface of the temperature-controlling element 8, the thermoelectric cooling element 13, the heat exchange element 12 and the fastening element 15a with an inner lateral surface. A dosed-cell polyurethane with a thermal conductivity of 1 W/(m·K) can be used as the insulation element 17a.

The insulation element 17a itself is in turn full-circumferentially surrounded by a layer element 18 on the outer lateral surface. The layer element 18, which protects the insulation element 17a from external wear and penetration of the cryogenic liquid 6, also covers at least the downward-facing end face of the insulation element 17a. The layer element 18 is preferably made of PTFE with a preferred wall thickness of 5 mm. The outer diameter of the hollow circular cylindrical area of the layer element 18 can be 55 mm, while the extension along the longitudinal axis L and consequently the height of the layer element 18 can be 230 mm. In addition to the layer element 18, the dosed cells of the foam of the insulation element 17a also prevent the cryogenic liquid 6, in particular liquid nitrogen, from penetrating into the insulation element 17a.

The first sub-area 15a-1 of the fastening element 15a is not surrounded by the insulation element 17a in order to guarantee the direct contact with the cryogenic liquid 6 on the outer lateral surface. A second sub-area 15a-2 of the fastening element 15a, however, is enveloped by the insulation element 17a, so that the second sub-area 15a-2 is not in contact with the cryogenic liquid 6. The first sub-area 15a-1 and the second sub-area 15a-2 of the fastening element 15a border one another on the plane of the downward-facing end face of the insulation element 17a, which is aligned perpendicular to the longitudinal axis L.

A temperature sensor 19 for determining the temperature of the wall of the temperature-controlling element 8 is arranged on the outer lateral surface of the temperature-controlling element 8 or within the wall of the temperature-controlling element 8, with which the temperature of the temperature-controlling element 8 and the sample 31 contained in the measuring cell 30 can be determined. For example, a conventional Pt1000 platinum measuring resistor can be used as the temperature sensor 19. The temperature sensor 19 is inserted into an opening formed in the temperature-controlling element 8, for example a hole with a length of 30 mm and a diameter in the range from 3 mm to 4 mm, in particular 3.1 mm.

The thermoelectric cooling element 13 designed as a Peltier element and the temperature sensor 19 are each connected to a regulating device 33. With the regulating device 33, designed for example as a PID regulator, the cooling power of the cooling element 13 is varied as specified by a target value of the temperature determined with the temperature sensor 19 in such a way that the desired target temperature is set at the temperature sensor 19.

The temperature sensor 19 and the electrical connections of the thermoelectric cooling element 13 are each led out of the vessel 4 to the outside via an electrical connection, in particular an electrical line, and connected to the regulating device 33. For a most accurate temperature measurement possible, the line of the temperature sensor 19 is wound several times, for example twice or three times, around the temperature-controlling element 8 along the outer lateral surface. The line of the temperature sensor 19 is cooled at least close to the temperature of the temperature-controlling element 8 in order to minimize heat input along the line of the temperature sensor 19 and to determine the actual temperature of the temperature-controlling element 8 at the measuring tip of the temperature sensor 19.

The temperature-controlling element 8 must always be arranged above the fill level line of the cryogenic liquid 6, so that the temperature-controlling element 8 does not come into contact with the cryogenic liquid 6 in order to ensure the function of the regulation. A direct contact of the temperature-controlling element 8 with the cryogenic liquid 6, for example by running the cryogenic liquid 6 into the temperature-controlling element 8 from above, would lead to uncontrolled cooling of the temperature-controlling element 8. The fastening element 15a must therefore be designed with a certain minimum extension along the longitudinal axis L, in particular a length, in order to fix the temperature-controlling element 8 above the fill level line of the cryogenic liquid 6 and in the upper area of the isolation container 2. At the same time, it must be ensured that the contact surface of the first sub-area 15a-1 of the fastening element 15a is arranged below the fill level line of the cryogenic liquid 6 in order to transfer the required heat to the cryogenic liquid 6 in a targeted manner.

FIG. 3 shows a second embodiment of a device 1b according to the invention for controlling the temperature of the measuring cell 30 with the measuring apparatus arranged within the insulation container 2.

Same components of the devices 1a, 1b are provided with same reference numerals and are designed with the same dimensions. The temperature-controlling element 8, heat exchange element 12 and thermoelectric cooling element 13 of the devices 1a, 1b, which are aligned coaxially and along the longitudinal axis L, are same and are each full-circumferentially jacketed on the outer lateral surface with an insulation element 17b, especially the insulation foam. To this end, the insulation element 17b in each case lies against the outer lateral surface of the temperature-controlling element 8, the thermoelectric cooling element 13, the heat exchange element 12 and the fastening element 15b, with its inner lateral surface. The insulation element 17b itself is in turn full-circumferentially surrounded on the outer lateral surface by the first layer element 18, which protects the insulation element 17b from extremal wear and the penetration of the cryogenic liquid 6.

The first sub-area 15b-1 of the fastening element 15b is, similar to the device 1a from FIG. 2a or 2b, not surrounded by the insulation element 17b in order to ensure the direct contact with the cryogenic liquid 6 on the outer surface.

The main difference between the device 1a according to FIGS. 2a and 2b and the device 1b according to FIG. 3 lies in the design of a multi-piece fastening element 15b.

The multi-piece design of the rod-shaped, in particular round rod-shaped, fastening element 15b as a heat-conducting element with several segments made of different materials, allows to set different mean thermal conductivity coefficients for the fastening element 15b without varying the diameter of the fastening element 15b.

The fastening element 15b of the device 1b is divided into three individual components: a heat dissipation element 20, a stand element 21 and a porous jacket element 22. The stand element 21 merely serves to arrange the measuring apparatus within the vessel 4 in the desired vertical position and is negligible in terms of dissipating the heat from the measuring apparatus to the cryogenic liquid 6. The stand element 21 made of aluminum can have an extension in the direction of the longitudinal axis L and consequently a height of 125 mm with an outer diameter of 30 mm. On the upper side pointing to the heat dissipation element 20, the stand element 21 can be formed with a metric external thread M8 for connecting, in particular for screwing, to the heat dissipation element 20.

The rod-shaped, in particular round rod-shaped, heat dissipation element 20 is made of a material with a high thermal conductivity coefficient, specifically with a thermal conductivity coefficient greater than 200 W/(m·K), for example made of copper. The heat dissipation element 20, which preferably has a diameter of more than 20 mm, for example 30 mm, and a length of less than 100 mm, in particular 55 mm, is in contact with the cryogenic liquid 6 in a first sub-area 15b-1 on the outer lateral surface. In this case, the diameter of the heat dissipation element 20 of the device 1b Is significantly larger than the diameter of the fastening element 15a of the device 1a from FIG. 2a which is thermally conductive over the entire length, and corresponds substantially to the outer diameter of the sleeve-shaped heat exchange element 12, while the length of the heat dissipation element 20 in the direction of the longitudinal axis L is significantly less than the length of the fastening element 15a of the device 1a from FIG. 2a.

The heat dissipation element 20 can have a metric external thread M8 at the upper end aligned with the heat sink 10 for screwing to the heat sink 10, while a metric internal thread M8 can be provided at the lower end of the heat dissipation element 20 distal to the upper end.

The porous jacket element 22, which full-circumferentially encloses the first sub-area 15b-1 of the fastening element 15b and the stand element 21 over the entire length and thus adjoins the insulation element 17b in the direction of the longitudinal axis L, fulfills the function of continuously conveying cryogenic liquid 6 as a cooling medium to the first sub-area 15b-1 of the thermally conductive fastening element 15b. The insulation element 17b and the jacket element 22 lie against one another on the end faces pointing to one another. Thus, the jacket element 22 is in no contact with the heat exchange element 12 or the temperature-controlling element 8 and thus the measuring cell 30, and also does not extend beyond the area which contains the sample 31.

In comparison to the first sub-area 15a-1 of the fastening element 15a of the device 1a from FIG. 2a and to the jacket element 22, the first sub-area 15b-1 of the fastening element 15b of the device 1b is not immersed in the cryogenic liquid 6.

The porous jacket element 22, which protrudes into the cryogenic liquid 6 at least with a lower area, acts as a wick for the cryogenic liquid 6. Via capillary force, the cryogenic liquid 6 is continuously conveyed to the first sub-area 15b-1 as a contact surface of the fastening element 15b within the pores of the jacket element 22 regardless of the filling level. Here, the filling level of the cryogenic liquid 6 can be below the vertical arrangement of the first sub-area 15b-1 of the fastening element 15b.

The hollow cylindrical, in particular hollow circular cylindrical, jacket element 22 is designed with a pore size of less than 40 μm, in particular a mean pore size of 20 μm, and is full-circumferentially enclosed by a second layer element 23 on the outer lateral surface over the entire length. The second layer element 23 prevents an exchange of cryogenic liquid 6 via the outer lateral surface of the jacket element 22, in particular a jacket-side escape of the cryogenic liquid 6 from the jacket element 22. Only the porous lower and upper end faces of the jacket element 22 are designed for the penetration and escape of the cryogenic liquid 6. This ensures that the cryogenic liquid 6 passed through the jacket element 22 does not penetrate into the area of the device 1b enclosed by the insulation element 17b.

The jacket element 22 is made of a plastic, specifically porous polyethylene, while non-porous polyethylene is preferably used as the second layer element 23. Here, the diameter of the inner lateral surface of the jacket element 22 corresponds to the diameter of the heat dissipation element 20 and the stand element 21, in particular 30 mm, which are also same, plus a clearance for assembly. The jacket element 22 can have an extension in the direction of the longitudinal axis L, or a height, of 145 mm with an outer diameter of 50 mm.

The support element 16, which has the shape of a circular disk, can be designed with an outer diameter of 36 mm in order to prevent the porous jacket element 22 from slipping.

The first layer element 18 of the device 1b can have an extension along the longitudinal axis L and consequently a height of 115 mm and can therefore be correspondingly shorter than the layer element 18 of the device 1a according to FIGS. 2a and 2b. It is also possible in this case to make the components of the device 1b arranged and connected within the vessel 4 shorter by about 10 mm compared to the device 1a, in particular to increase the distance of the temperature-controlling element 8 from the cover element 3 and thus improve the thermal decoupling and to obtain lower measuring temperatures.

### LIST OF REFERENCE NUMERALS

1a, 1b device
2 insulation container
3 cover element
4 vessel
5 cavity
6 cryogenic liquid
7 through opening of cover element 3
8 temperature-controlling element
9 receiving opening of temperature-controlling element 8
10 heat sink
11 shunt element
12 heat exchange element
13 thermoelectric cooling element
14-1 first spring element
14-2 second spring element
15a, 15b fastening element
15a-1, 15b-1 first sub-area of fastening element 15a, 15b
15a-2 second sub-area of fastening element 15a
16 support element
17a, 17b Insulation element
18 (first) layer element
19 temperature sensor
20 heat dissipation element of fastening element 15b
21 stand element of fastening element 15b
22 jacket element of fastening element 15b
23 second layer element
30 measuring cell
31 sample
32 gas sorption instrument
33 regulating device
L longitudinal axis
M measuring point
B control volume
K heat sink
Qₐ heat from the environment
Qᵢₖ, heat through insulation from device 1
Q_{iw} heat through insulation in device 1
Q_{H} thermal heat
Q_{K} cooling heat

1-25. (canceled)

26. A device for controlling the temperature of a gas sorption measuring cell, comprising:
an insulated vessel for receiving a cooling medium and
a measuring apparatus comprising a temperature controlling element having a receiving opening for receiving the measuring cell and a cooling device for controlling the temperature of the temperature controlling element, which are aligned in the direction of a longitudinal axis and are arranged adjacent to one another in a heat-transferring manner, wherein the cooling device has a fastening element for fixing the temperature control element on a wall of the vessel and for heat transfer between the measuring apparatus and the cooling medium, characterized in that a thermoelectric cooling element for cooling the temperature control element and the measuring cell is arranged in the direction of the longitudinal axis (L) between the temperature control element and the cooling device.

27. The device according to claim 26, wherein the thermoelectric cooling element is disk-shaped and has an underside contacting the temperature-controlling element and an upper side aligned in the direction of the longitudinal axis.

28. The device according to claim 26, wherein the thermoelectric cooling element is designed as a Peltier element.

29. The device according to claim 26, further comprising a temperature sensor designed to determine the temperature of the temperature-controlling element and the measuring cell, and a regulating device, wherein the temperature sensor is connected to the regulating device.

30. The device according to claim 29, wherein
the thermoelectric cooling element is electrically connected to the regulating device, and
the regulating device receives a signal from the temperature sensor and controls the thermoelectric cooling element so as to keep a specified target value of the temperature of the temperature-controlling element constant based on the received signal.

31. The device according to claim 26, wherein the cooling device comprises a heat sink, a heat exchange element, and a spring element.

32. The device according to claim 31, wherein the heat sink and the fastening element are designed to be in direct contact and firmly connected to one another or are designed in one piece.

33. The device according to claim 31, wherein the cooling device comprises a thermal shunt element arranged between the heat sink and the temperature-controlling element in the direction of the longitudinal axis, wherein the heat sink and the shunt element as well as the shunt element and the temperature-controlling element are each firmly connected to one another.

34. The device according to claim 31, wherein the thermoelectric cooling element is arranged between the temperature-controlling element and the heat exchange element in the direction of the longitudinal axis.

35. The device according to claim 31, wherein the spring element is arranged so as to press the thermoelectric cooling element against the temperature-controlling element by a spring force of the spring element.

36. The device according to claim 31, wherein the spring element is designed as a disk spring and is arranged between the heat sink and the heat exchange element in the direction of the longitudinal axis.

37. The device according to claim 31, wherein
the heat sink has a shape of a cylinder with a cylinder axis aligned in the direction of the longitudinal axis and a collar protruding from an outer lateral surface in a radial direction,
wherein the heat exchange element is designed in a shape of a hollow cylinder with a heat-exchange-element axis aligned in the direction of the longitudinal axis, and
wherein the outer lateral surface of the heat sink and an inner lateral surface of the heat exchange element are designed to correspond to one another and are arranged so as to contact one another over an entire surface, and wherein the heat exchange element is movable in the direction of the longitudinal axis with respect to the heat sink.

38. The device according to claim 37, wherein the heat exchange element comprises on an end face oriented toward the temperature-controlling element a collar protruding from the inner lateral surface in the radial direction.

39. The device according to claim 37, wherein the spring element is arranged between an upper side of the collar of the heat sink and an end face of the heat exchange element opposite the collar.

40. The device according to claim 37, wherein the spring element is arranged between the upper side of the heat sink pointing toward the cooling element and the collar protruding from the inner lateral surface of the heat exchange element in the radial direction.

41. The device according to claim 26, wherein the fastening element comprises a sub-area in direct contact with the cooling medium.

42. The device according to claim 31, wherein the temperature-controlling element, the thermoelectric cooling element, the heat exchange element and a sub-area of the fastening element are aligned coaxially to the longitudinal axis and are each full-circumferentially surrounded by an insulation element on an outer lateral surface.

43. The device according to claim 42, wherein the insulation element is full-circumferentially surrounded by a layer element on an end face aligned downwards in the direction of the longitudinal axis and on the outer lateral surface.

44. The device according to claim 26, wherein the fastening element is rod-shaped and designed in one piece or as multiple pieces.

45. The device according to claim 44, wherein the fastening element is formed from a heat dissipation element, a stand element and a jacket element, which are arranged coaxially to the longitudinal axis, wherein the heat dissipation element and the stand element about each other on end faces that face one another in the direction of the longitudinal axis.

46. The device according to claim 45, wherein at least a sub-area of the jacket element made of a porous material and arranged within the cooling medium encloses a first sub-area of the fastening element and the stand element full-circumferentially on the lateral surface and in the direction of the longitudinal axis, wherein the sub-area of the jacket element is configured to transport the cooling medium to the first sub-area of the fastening element.

47. The device according to claim 45, wherein the jacket element has a hollow cylindrical shape and is full-circumferentially surrounded by a layer element on an outer lateral surface.

48. A method for operating a device for controlling the temperature of a measuring cell according to any one of claims 1 to 22 and keeping the temperature of the measuring cell constant at a specified target value in a time interval for carrying out analyses, comprising:
Immersing the fastening element of the cooling device, which is in thermally conductive contact with the measuring cell for heat exchange via the temperature-controlling element, into the cooling medium;
determining the temperature of the temperature-controlling element and comparing the determined temperature with the specified temperature target value;
regulating the temperature of the temperature-controlling element with the thermoelectric cooling element that is thermally coupled to the temperature-controlling element to a specified target temperature to cool the temperature-controlling element; and
keeping the temperature of the measuring cell constant at the specified target value in a time interval sufficient to carry out an analysis.

49. The method according to claim 48, further comprising
pressing the thermoelectric cooling element against the temperature-controlling element with the spring element to compensate for different thermal expansions.

50. The method according to claim 48, further comprising
arranging between the temperature-controlling element and the fastening element a shunt element for controlling and regulating a temperature range of the measuring cell, wherein the temperature range is determined by a material and a dimension of the shunt element.
